(19) United States
(12) Patent Application Publication
(10) Pub. No.: US 2026/0138537 A1
(43) Pub. Date: May 21, 2026

(54) ADJUSTABLE TRAY SYSTEM FOR CARGO SPACE IN A VEHICLE

(71) Applicant: General Devices Co., INC., Indianapolis, IN (US)

(72) Inventor: Elizabeth Kokinos, Fishers, IN (US)

(21) Appl. No.: 19/393,085

(22) Filed: Nov. 18, 2025

Related U.S. Application Data
(60) Provisional application No. 63/722,562, filed on Nov. 19, 2024.

(51) Int. Cl. B60R 5/04

(52) U.S. Cl. CPC B60R 5/041

(57) ABSTRACT

A tray system includes a left-side telescoping slide assembly, a right-side telescoping slide assembly, and an expandable tray. The left-side and right-side telescoping slide assembly each include interconnected, slide members moveable to extend and retract in a longitudinal direction between a retracted-storage stage and extended-service stage. The expandable tray is coupled to the left-side and right-side telescoping slide assemblies for movement therewith.

### CROSS REFERENCE TO RELATED APPLICATIONS

This application claims priority to and the benefit of U.S. Provisional Patent Application Number 63/722,562, filed 19 Nov. 2024, the disclosure of which is now expressly incorporated herein by reference.

### BACKGROUND

The present invention relates to tray systems for cargo spaces in vehicles, and particularly an adjustable tray system for a cargo space in a vehicle. More particularly, the present invention relates to an adjustable tray system for a cargo space in a vehicle that has a telescoping slide system that moves longitudinally and an expandable tray couples to the telescoping slide system that moves laterally.

A conventional tray system typically includes a slide system having telescoping slide assemblies that move between a retracted position and an extended position. Typically, a pair of telescoping slide assemblies are positioned in side-by-side spaced-apart parallel relation so that either a load-carrying platform or one or more pieces of equipment can be carried on the two side-by-side load-carrying slide members. The slide assemblies may be mounted to a fixed frame, such as a trunk bed of a vehicle, to anchor the slide assembly. In this way, such loads can be moved easily relative to the trunk bed or the like during telescoping extension and retraction of each slide assembly, allowing an operator better access to the loads in the trunk of the vehicle.

Different vehicles, depending on the type, make, and/or model, have cargo space or trunk space with varying depths and widths. Alternatively, the loads anchored to the slide system may have different sizes or dimensions such that the slide assemblies may need to be manually repositioned. Manually adjusting the positions of the slide assemblies may be difficult and time consuming. In other instances, the position of the slide assemblies within the trunk bed may be limited to ensure the slide assemblies are properly anchored to structurally sound areas of the vehicle.

### SUMMARY

A tray system adapted for use in a trunk of a vehicle may comprise a left-side telescoping slide assembly adapted to be coupled to the trunk of the vehicle, a right-side telescoping slide assembly adapted to be coupled to the trunk of the vehicle in spaced apart relation to the left-side telescoping slide assembly, and an expandable tray. The left-side telescoping slide assembly may include interconnected, slide members moveable to extend and retract in a longitudinal direction between a retracted-storage stage and extended-service stage. The right-side telescoping slide assembly may include interconnected, slide members moveable to extend and retract with the left-side telescoping slide assembly among the retracted-storage stage and the extended-service stage. The expandable tray may be coupled to the left-side and right-side telescoping slide assemblies for movement therewith.

In some embodiments, the expandable tray may include a base plate and a pair of adjustable panels. The base plate may be coupled to the left-side and right-side telescoping slide assemblies. The pair of adjustable panels may be configured to extend and retract in a lateral direction perpendicular to the longitudinal direction between a plurality of predetermined positions to adjust a width of the expandable tray.

In some embodiments, the base plate may be formed to include a plurality of slots formed in the base plate and spaced apart from each other in the lateral direction. Each panel may be formed to include at least one lock tab that extends away from the panel.

In some embodiments, the at least one lock tab on each panel of the plurality of adjustable panels may cooperate with any one of the plurality of slots in the base plate to provide a locking system. The locking system may be configured block the pair of adjustable panels from extending and retracting in the lateral direction when in any one of the plurality of predetermined positions once the at least one lock tab on each panel of the plurality of adjustable panels is inserted and translated in the longitudinal direction.

In some embodiments, the locking system may further include a plurality of fasteners. The plurality of fasteners may be configured to change between an inserted position in which each fastener of the plurality of fasteners extends through the pair of adjustable panels and into the base plate when the pair of adjustable panels are in any one of the plurality of predetermined positions to further block the pair of adjustable panels from extending and retracting in the lateral direction and a removed position in which each fastener of the plurality of fasteners is spaced apart from the expandable tray to allow the pair of adjustable panels to extend and retract in the lateral direction between the plurality of predetermined positions.

In some embodiments, the base plate may be formed to include holes for each fastener of the plurality of fasteners. The pair of adjustable panels may each be formed to include a plurality of through holes configured to align with the holes in the base plate in any one of the plurality of predetermined positions so that each fastener of the plurality of fasteners extends through one of the plurality of through holes in the pair of adjustable panels and into the hole in the base plate when in the inserted position.

In some embodiments, the plurality of fasteners may include at least four fasteners. The plurality of through holes may include a first row of through holes associated with a first fastener, a second row of through holes associated with a second fastener, a third row of through holes associated with a third fastener, and a fourth row of through holes associated with a fourth fastener.

In some embodiments, the at least one lock tab on each panel of the plurality of adjustable panels may have a hook shape. The hook shape may have a vertically-extending section that extends in a downward-vertical direction from the panel and a longitudinally-extending section that extends in the longitudinal direction from the vertically-extending section.

In some embodiments, each panel of the pair of adjustable panels may be formed to include more than one lock tab spaced apart in the longitudinal direction. In some embodiments, each panel of the pair of adjustable panels may be formed to include three lock tabs spaced apart from each other in the longitudinal direction.

In some embodiments, the plurality of slots in the base plate may include three rows of slots spaced apart from each other in the longitudinal direction. The three rows of slots may include a first row of slots associated with first lock tabs on the pair of adjustable panels, a second row of slots associated with second lock tabs on the pair of adjustable panels, and a third row of slots associated with second lock tabs on the pair of adjustable panels.

In some embodiments, the lock tabs on each panel of the plurality of adjustable panels may have a hook shape. The hook shape may have a vertically-extending section that extends in a downward-vertical direction from the panel and a longitudinally-extending section that extends in the longitudinal direction from the vertically-extending section.

In some embodiments, each panel of the pair of adjustable panels may include a bottom panel wall, the at least one lock tab, and a side wall. The bottom panel may extend from a first longitudinal edge and a second longitudinal edge spaced apart laterally from the first longitudinal edge. The least one lock tab may extend vertically away from the bottom panel wall in a downward-vertical direction near the first longitudinal edge. The side wall may extend vertically away from the bottom panel wall in an upward-vertical direction opposite the downward-vertical direction near the second longitudinal edge.

According to another aspect of the present disclosure, a method may comprise arranging a tray system in a trunk of a vehicle. The tray system may comprise a left-side telescoping slide assembly including interconnected, slide members moveable to extend and retract in a longitudinal direction between a retracted-storage stage and extended-service stage, a right-side telescoping slide assembly including interconnected, slide members moveable to extend and retract with the left-side telescoping slide assembly among the retracted-storage stage and the extended-service stage, and an expandable tray coupled to the left-side and right-side telescoping slide assemblies for movement therewith.

In some embodiments, the expandable tray may include a base plate and a pair of adjustable panels. The base plate may be coupled to the left-side and right-side telescoping slide assemblies and formed to include a plurality of slots formed in the base plate and spaced apart from each other in the lateral direction. The pair of adjustable panels may each be formed to include at least one lock tab that extends away from the panel, wherein the pair of adjustable panels spaced apart at a first lateral distance.

In some embodiments the method may further comprise removing a plurality of fasteners that extend through the pair of adjustable panels into the base plate, translating the pair of adjustable panels in a first longitudinal direction to align the at least one lock tab with a corresponding slot so that the at least one lock tab may be moved out of the corresponding slot, and lifting the pair of adjustable panels in an upward-vertical direction away from the base plate after translating the pair of adjustable panels in the first longitudinal direction to space the at least one lock tab of each panel away from the base plate.

In some embodiments, the method may further comprise moving the pair of adjustable panels in a lateral direction perpendicular to the longitudinal direction. The pair of adjustable panels may be moved in the lateral direction so that the pair of adjustable panels are spaced apart at a second lateral distance that is different from the first lateral distance to adjust the width of the expandable tray.

In some embodiments, the method may further comprise lowering the pair of adjustable panels in a downward-vertical direction opposite the upward-vertical direction toward the base plate to insert the at least one lock tab of each panel into one slot of the plurality of slots, translating the pair of adjustable panels in a second longitudinal direction opposite the first longitudinal direction to misalign the at least one lock tab with a corresponding slot so that the at least one lock tab is unable to be moved out of the corresponding slot, and inserting the plurality of fasteners through the pair of adjustable panels into the base plate.

Additional features of the present disclosure will become apparent to those skilled in the art in response to consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a tray system in accordance with the present disclosure adapted to be arranged in a trunk of a vehicle, the tray system comprising left-side and right-side telescoping slide assemblies movable to extend and retract among a RETRACTED-STORAGE stage as shown in FIG. 3A and an EXTENDED-SERVICE stage as shown in FIG. 3B and an expandable tray coupled to the left-side and right-side telescoping slide assemblies for movement therewith between the RETRACTED-STORAGE stage and the EXTENDED-SERVICE stage and configured to expand and retract between like as shown in FIGS. 4-9 to adjust the width of the expandable tray to fit within the trunk of the vehicle;

FIG. 2 is perspective view similar to FIG. 1 showing the expandable tray includes a base plate coupled to the left-side and right-side telescoping slide assemblies and a pair of adjustable panels configured to expand and retract between a FULLY-RETRACTED mode as shown in FIG. 4A and a FULLY-EXPANDED mode as shown in FIG. 4B, and further showing a plurality of lock tabs on each panel at least one lock tab on each panel of the plurality of adjustable panels cooperates with any one of the plurality of slots in the base plate to provide a locking system configured block the pair of adjustable panels from extending and retracting in a lateral direction when in any one of the plurality of predetermined positions once the at least one lock tab on each panel of the plurality of adjustable panels is inserted and translated in the longitudinal direction;

FIG. 3A is a perspective view the vehicle with the tray system of FIG. 1 installed showing the left-side and right-side telescoping slide assemblies are in the RETRACTED-STORAGE stage in which the tray system is within the trunk of the vehicle;

FIG. 3B is a perspective view similar to FIG. 3A showing the left-side and right-side telescoping slide assemblies have moved from the RETRACTED-STORAGE stage to the EXTENDED-SERVICE stage;

FIG. 4A is a rear view of the vehicle with the tray system of FIG. 1 installed showing the expandable tray is in a FULLY-RETRACTED mode in which the pair of adjustable panels are located in a FIRST position so that the tray has a first width;

FIG. 4B is a view similar to FIG. 4A showing expandable tray has moved from the FULLY-RETRACTED mode to the FULLY-EXPANDED mode in which the pair of adjustable panels are located in a SECOND position so that the tray has a second width that is greater than the first width;

FIG. 5 is an exploded view of the expandable tray of FIG. 1 showing the expandable tray comprises (i) the base panel formed to include three rows of slots spaced apart from each other in a longitudinal direction with the slots of each row spaced apart in the lateral direction, (ii) the pair of adjustable panels each formed to include three lock tabs that are configured to cooperate with the rows of slots in the base plate to provide a locking system configured block the pair of adjustable panels from extending and retracting once the lock tabs on each panel is inserted into one of the slots and translated in the longitudinal direction, and (iii) a plurality of fasteners that are configured to be change between an INSERTED position as shown in FIGS. 6 and 13 and a REMOVED position as shown in FIGS. 7-12;

FIG. 6 is a view similar to FIG. 1 showing the expandable tray in the FULLY-RETRACTED mode in which the pair of adjustable panels are in the FIRST position and the locking system is in an ENGAGED mode in which the plurality of fasteners are in the INSERTED position and the lock tabs are in an INSERTED-ENGAGED position;

FIG. 7 is a view similar to FIG. 6 showing the plurality of fasteners have been moved from the INSERTED position in which each fastener of the plurality of fasteners extends through the pair of adjustable panels and into the base plate to further block the pair of adjustable panels from extending and retracting in the lateral direction to the REMOVED position in which each fastener of the plurality of fasteners is spaced apart from the expandable tray while the lock tabs remain in the INSERTED-ENGAGED position to allow the pair of adjustable panels to be translated in the longitudinal direction;

FIG. 8 is a view similar to FIG. 7 showing the pair of adjustable panels have been translated in a first longitudinal direction to cause the lock tabs to change from the INSERTED-ENGAGED position to an INSERTED-DISENGAGED position in which each of the lock tabs are aligned with a corresponding slot so that the at least one lock tab may be moved out of the corresponding slot so that the pair of adjustable panels may be extended or retracted in the lateral direction;

FIG. 9 is a view similar to FIG. 8 showing the pair of adjustable panels have been lifted in an upward-vertical direction away from the base plate after translating the pair of adjustable panels in the first longitudinal direction to cause the lock tabs to change from the INSERTED-DISENGAGED position to a REMOVED-DISENGAGED position in which each of the lock tabs are spaced away from the base plate;

FIG. 10 is a view similar to FIG. 9 showing the pair of adjustable panels have been moved in the lateral direction from the FIRST position to the SECOND position while the lock tabs remain in the REMOVED-DISENGAGED position;

FIG. 11 is a view similar to FIG. 10 showing the pair of adjustable panels have been lowered in a downward-vertical direction opposite the upward-vertical direction toward the base plate to cause the lock tabs to change from the REMOVED-DISENGAGED position to the INSERTED-DISENGAGED position in which the lock tabs of each panel are inserted into corresponding slots associated with the SECOND position to block the pair of adjustable panels from being moved in the lateral direction;

FIG. 12 is a view similar to FIG. 11 showing the pair of adjustable panels have been translated in a second longitudinal direction opposite the first longitudinal direction to cause the lock tabs to change from the INSERTED-DISENGAGED position to the INSERTED-ENGAGED position in which the lock tabs of each panel are misaligned with a corresponding slot so that the lock tabs are unable to be moved out of the corresponding slot; and

FIG. 13 is view similar to FIG. 12 showing the plurality of fasteners have been moved from the REMOVED position to the INSERTED position while the lock tabs remain in the INSERTED-ENGAGED position to further block the pair of adjustable panels from extending and retracting in the lateral direction once the panels are in the SECOND position.

### DETAILED DESCRIPTION

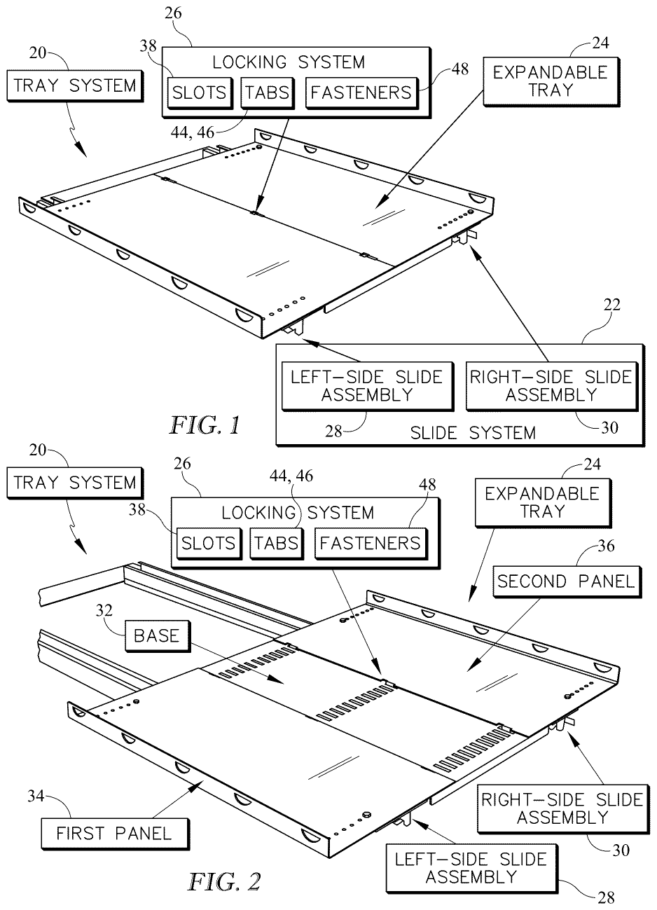

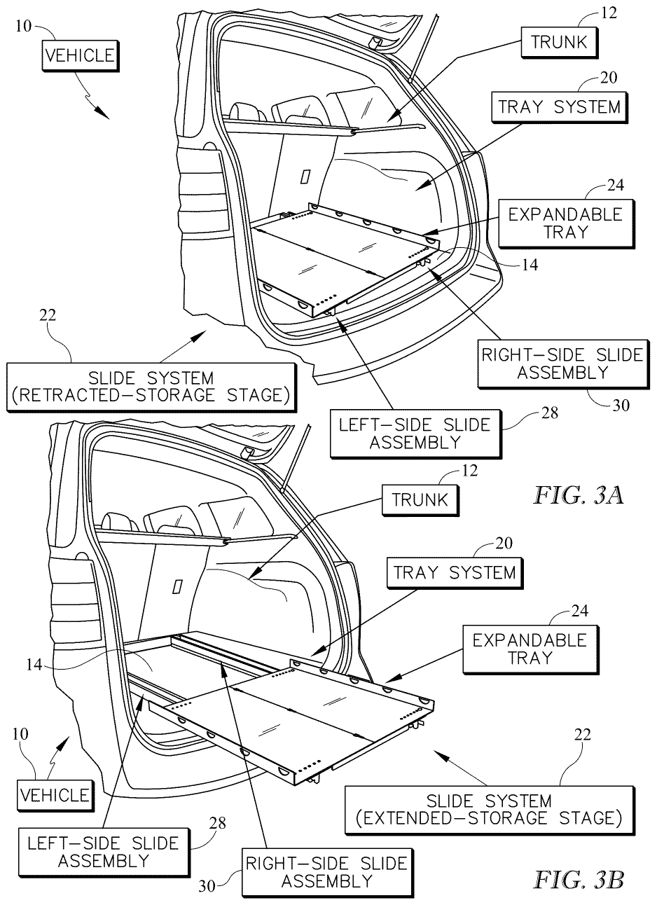

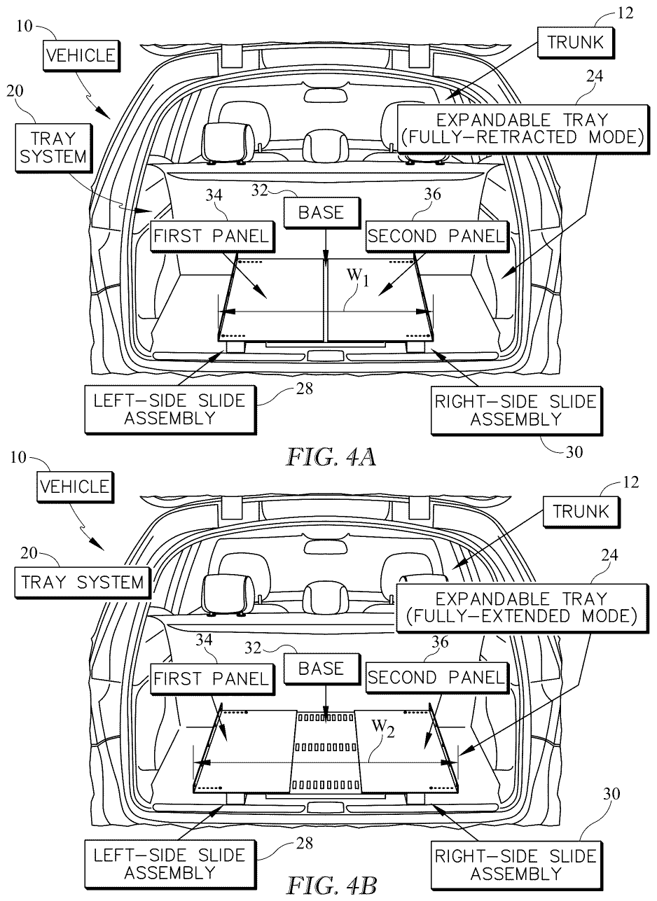

A tray system 20 illustrated in FIG. 1 includes a telescoping slide system 22 and an expandable tray 24 coupled to the telescoping slide system 22. The tray system 20 is adapted for use in a trunk 12 of a vehicle 10 as suggested in FIGS. 3A-4B. The telescoping slide system 22 is configured to extend and retract in a longitudinal direction, as suggested by arrow A, so that the expandable tray 24 may be moved in and out of the trunk 12 of the vehicle 10 for easier access. The expandable tray 24 has adjustable panels that expand and retract in a lateral direction, as suggested by arrow B, perpendicular to the longitudinal direction to adjust a width of the tray 24. In this way, the tray 24 may be sized to fit within and/or fill the area of the trunk 12 to utilize the full capacity of the trunk 12.

Vehicles can have cargo spaces that can hold more items than are easily accessible. One solution to the problem of accessing items in these hard to reach or inaccessible areas is the use of an extendable tray system. Conventional tray systems may include a slide system having telescoping slide assemblies that move between a retracted position and an extended position so that loads coupled thereto can be moved easily relative to the vehicle in and out of the cargo space during telescoping extension and retraction of each slide assembly, allowing an operator better access.

The slide assemblies of the slide system may be mounted to a fixed frame, such as a trunk bed or the like, to anchor the slide system. However, different vehicles, depending on the type, make, and/or model, have cargo space or trunk space with varying depths and widths. Moreover, the loads carried by or anchored to the slide system may have different sizes or dimensions such that the slide assemblies may need to be manually repositioned. Manually adjusting the positions of the slide assemblies may be difficult and time consuming. In some cases, the position of the slide assemblies within the trunk bed may be limited to ensure the slide assemblies are properly anchored to structural anchor points on the vehicle.

The tray system 20 of the present disclosure includes the expandable tray 24 that is configured to expand and retract in the lateral direction to allow an operator to adjust the width of the tray 24 without needing to manually reposition the slide assemblies 28, 30. The expandable tray 24 can even be adjusted while the tray system 20 is installed in the trunk 12 of the vehicle 10 instead of needing to remove the entire system 20 to reposition the different components.

Further, the locking system 26 included in the tray system 20 provides a quick and easy means for blocking movement of the expandable tray 24 when in any one of the predetermined positions. Unlike other locking systems, the locking system 26 includes multiple, redundant locking features, i.e. the lock tabs 44, 46 and the plurality of fasteners 48, that are quickly engaged and disengaged to adjust the width of the tray 24 as needed.

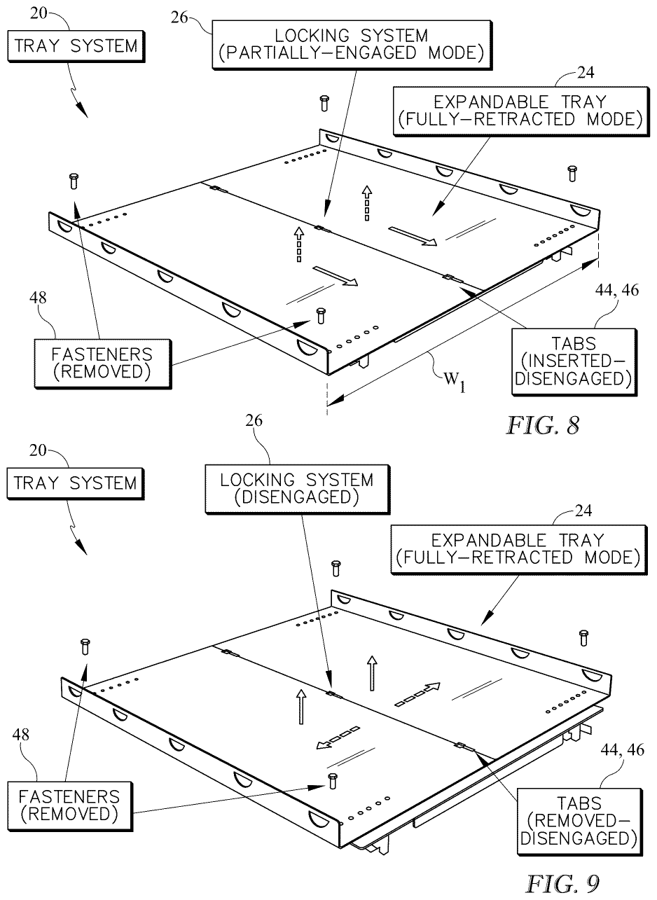

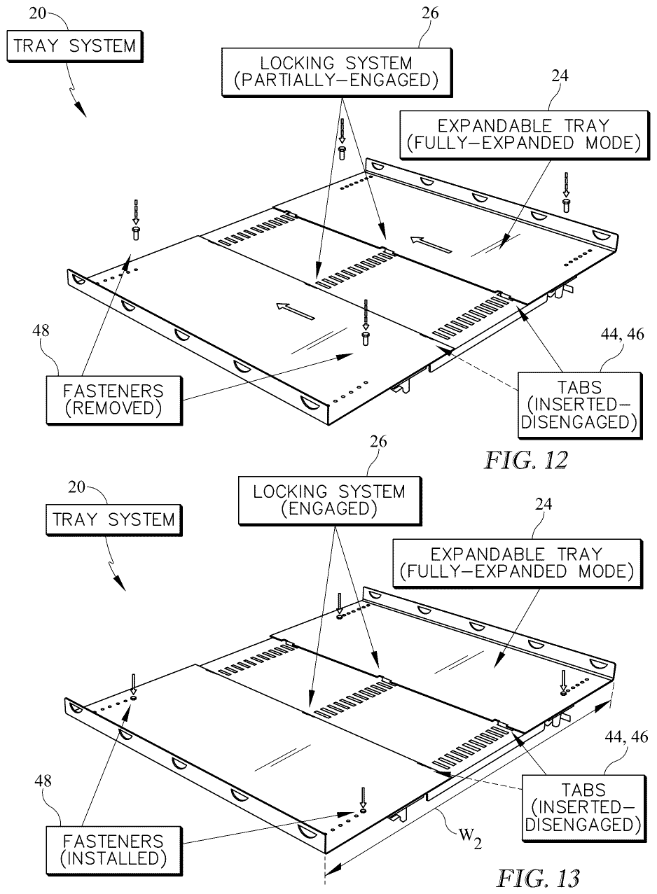

The tray system 20 includes the telescoping slide system 22, the expandable tray 24, and a locking system 26 as shown in FIGS. 1-13. The telescoping slide system 22 is coupled to the vehicle 10 within the cargo space of the trunk 12. The expandable tray 24 is coupled to the telescoping slide system 22 for movement therewith. The locking system 26 is configured to block movement of the expandable tray 24 from expanding and retracting in the lateral direction.

The telescoping slide system 22 includes a left-side telescoping slide assembly 28 and a right-side telescoping slide assembly 30 as shown in FIGS. 1-5. The left-side telescoping slide assembly 28 is adapted to be coupled to the trunk 12 of the vehicle 10. The right-side telescoping slide assembly 30 is adapted to be coupled to the trunk 12 of the vehicle 10 in spaced apart relation to the left-side telescoping slide assembly 28. Each of the left-side and the right-side telescoping slide assemblies 28, 30 include interconnected, slide members moveable to extend and retract in a longitudinal direction between the RETRACED-STORAGE stage as shown in FIG. 3A and EXTENDED-SERVICE stage as shown in FIG. 3B.

The telescoping slide system 22 is similar to or the same as the telescoping slide system described in U.S. Pat. No. 11,986,090, which is incorporated herein by reference. The telescoping slide system 22 may have a toolless release feature coupled to the left-side and the right-side telescoping slide assemblies 28, 30 for controlling movement of the telescoping slide assemblies between the RETRACTED-STORAGE stage, EXTENDED-SERVICE stage, a PRE-REMOVAL stage, and a REMOVAL stage. The toolless release feature enables a technician to remove the tray 24 mounted to load-carrying slide members of each telescoping slide assembly 28, 30 from the trunk of the vehicle 10 without the use of any tools.

The expandable tray 24 includes a base plate 32, a left adjustable panel 34, and a right adjustable panel 36 as shown in FIGS. 1-13. The base plate 32 is coupled to the left-side and right-side telescoping slide assemblies 28, 30. The pair of adjustable panels 34, 36 are configured to extend and retract in a lateral direction perpendicular to the longitudinal direction between a plurality of predetermined positions to adjust the width of the expandable tray 24.

The base plate 32 is formed to include a plurality of slots 38 as shown in FIGS. 2, 4B, and 5. The slots 38 are spaced apart from each other in the lateral direction. Each of the slots 38 has an elongated, oblong shape in the illustrative embodiments. As shown in FIGS. 2, 4B, and 5, each slot 38 is stretch or elongated in the lateral direction.

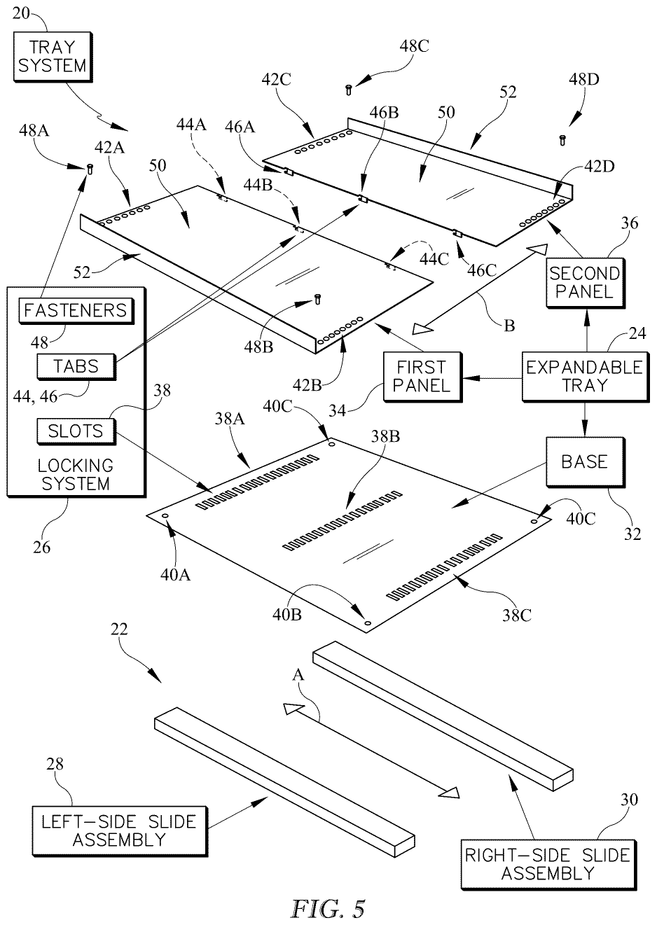

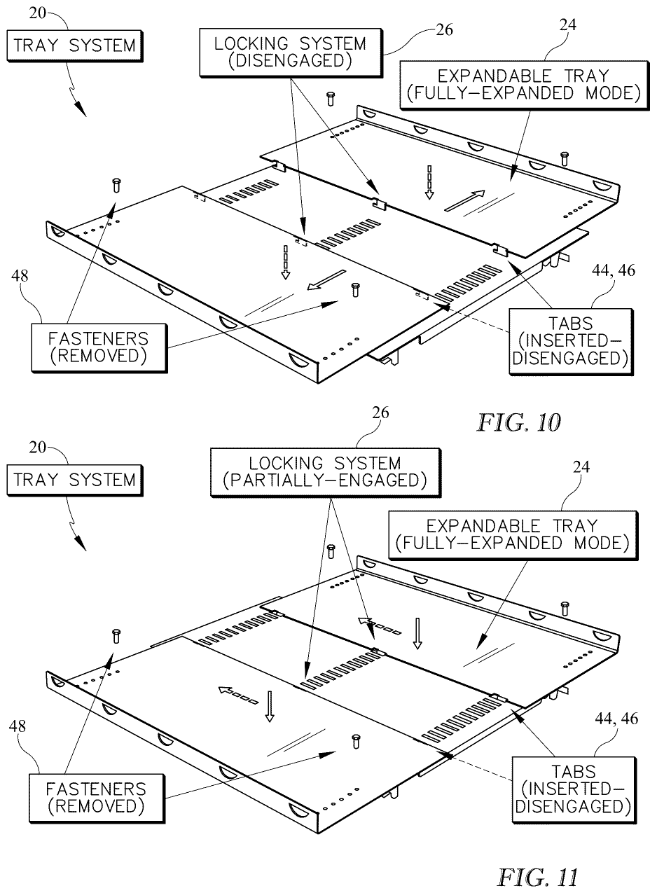

Each panel 34, 36 is formed to include at least one lock tab 44, 46 as shown in FIGS. 5 and 10. The lock tab 44, 46 extends away from the respective panels 34, 36. In the illustrative embodiments, the lock tab 44, 46 on each panel 34, 36 has a hook shape. The hook shape of the lock tabs 44, 46 of each panel 34, 36 has a vertically-extending section that extends in a downward-vertical direction from the respective panel 34, 36 and a longitudinally-extending section that extends in the longitudinal direction from the vertically-extending section like as shown in FIG. 5.

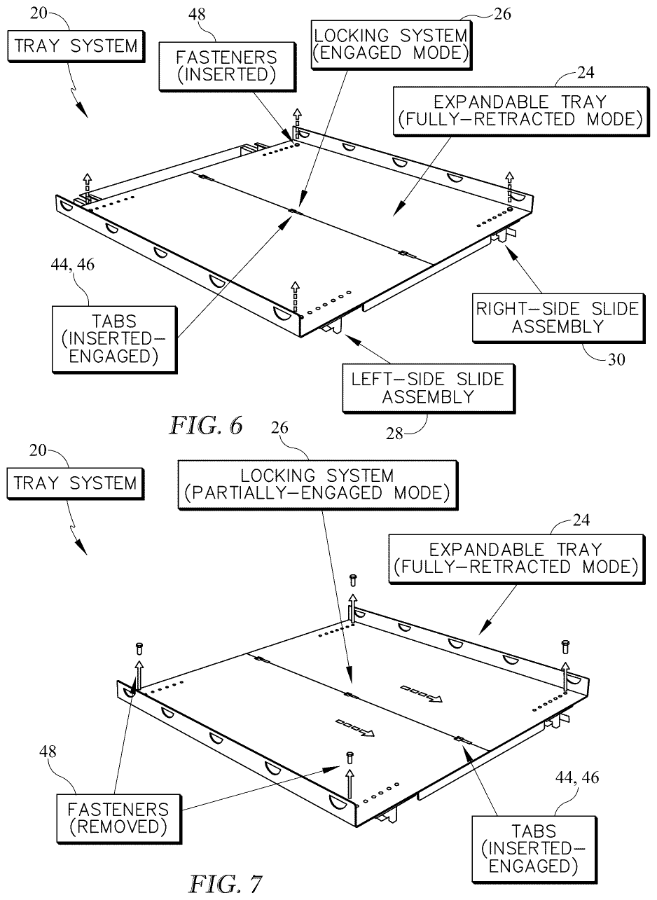

Each lock tab 44, 46 on each panel 34, 36 of the plurality of adjustable panels 34, 36 cooperates with any one of the plurality of slots 38 in the base plate 32 to provide the locking system 26 of the tray system 20. The locking system 26 is configured block the pair of adjustable panels 34, 36 from extending and retracting in the lateral direction once the lock tab 44, 46 on each panel 34, 36 of the plurality of adjustable panels 34, 36 is inserted and translated in the longitudinal direction. The locking system 26 is configured to change between different modes (e.g., ENGAGED mode as shown in FIGS. 6 and 13, PARTIALLY-ENGAGED mode as shown in FIGS. 7-8 and 11-12, and DISENGAGED mode as shown in FIGS. 9 and 10).

In the ENGAGED mode, each lock tab 44, 46 is in an INSERTED-ENGAGED position in which each of the lock tabs 44, 46 are inserted into one of the slots 38 in the base plate 32 and block movement of the respective panel 34, 36 in the lateral direction and an upward-vertical direction opposite the downward-vertical direction away from the base plate 32. In the PARTIALLY-ENGAGED mode, each lock tab 44, 46 is in an INSERTED-DISENGAGED position in which each of the lock tabs 44, 46 are inserted into one of the slots 38 in the base plate 32 to block movement of the respective panel 34, 36 in the lateral direction while allowing the panel 34, 36 to be moved in the upward-vertical direction. In the DISENGAGED mode, each lock tab 44, 46 is in a REMOVED-DISENGAGED position in which each of the lock tabs 44, 46 are located out of the slots 38 in the base plate 32 to allow movement of the respective panel 34, 36 in the lateral direction.

In the illustrative embodiment, the plurality of slots 38 include a first row of slots 38A, a second row of slots 38B, and a third row of slots 38C and the panels 34, 36 each include three lock tabs 44A-C, 46A-C as shown in FIGS. 2, 4B, and 5. The rows of slots 38A-C are spaced apart in the longitudinal direction. Each of the slots 38 is spaced apart from each other in the lateral direction. The lock tabs 44A-C, 46A-C on each panel 34, 36 is spaced apart in the longitudinal direction.

Each row of slots 38A-C corresponds to a pair of lock tabs 44A-C, 46A-C on each panel 34, 36. For example, the first lock tabs 44A, 46A correspond to the first row of slots 38A, the second lock tabs 44B, 46B correspond to the second row of slots 38B, and the third lock tabs 44C, 46C correspond to the third row of slots 38C.

The position or location of the slots 38 define the predetermined positions of the adjustable panels 34, 36. The two closest, adjacent slots 38 (i.e. center slots 38) define the FULL-RETRACTED position as shown in FIGS. 4A and 6, while the two end slots 38 define the FULLY-EXPANDED position as shown in FIGS. 4B and 13. In the FULLY-RETRACTED or FIRST position, the tray has a first width W₁. In the FULLY-EXPANDED or SECOND position, the tray has a second width W₂ that is greater than the first width. The slots 38 in between define the other INTERMEDIATE positions that define different widths greater than the first width W₁ and less than the second width W₂.

In the illustrative embodiments, the locking system 26 includes a plurality of fasteners 48 as shown in FIGS. 2-5. The fasteners 48 are configured to be changed between an INSERTED position as shown in FIGS. 6 and 13 and a REMOVED position as shown in FIGS. 7-12. In the INSERTED position, each fastener 48A-D of the plurality of fasteners 48 extends through the pair of adjustable panels 34, 36 and into the base plate 32 when the pair of adjustable panels 34, 36 are in any one of the plurality of predetermined positions to further block the pair of adjustable panels 34, 36 from extending and retracting in the lateral direction. In the REMOVED position, each fastener 48A-D of the plurality of fasteners 48 is spaced apart from the expandable tray 24 to allow the pair of adjustable panels 34, 36 to extend and retract in the lateral direction between the plurality of predetermined positions.

In the illustrative embodiment, the locking system 26 includes at least four fasteners 48A-D, with one fastener 48A-D located at each corner of the tray 24 as shown in FIG. 5. In some embodiments, the number of fasteners 48 may be less than or greater than four fasteners 48. In the illustrative embodiment, the fasteners 48 are bolts. In other embodiments, the fasteners 48 may be any suitable fastener, such as bolts, nuts, washers, screws, pins, etc.

Turning again to the base plate 32, the base plate 32 is formed to include the rows of slots 38-C and holes 40A-D for each fastener 48A-D of the plurality of fasteners 48 as shown in FIG. 5. The fasteners 48A-D extend into the holes 40A-D in the base plate 32 when in the INSERTED position.

The pair of adjustable panels 34, 36 are each formed to include a plurality of through holes 42 configured to align with the holes 40A-D in the base plate 32 in any one of the plurality of predetermined positions so that each fastener 48A-D of the plurality of fasteners 48 extends through one of the plurality of through holes 42 in the pair of adjustable panels 34, 36 and into the corresponding hole 40A-D in the base plate 32 when in the INSERTED position. In the illustrative embodiment, each adjustable panel 34, 36 has two rows of through holes 42A-D for a total of four rows of through holes 42A-D, one for each fastener 48A-D. The through holes 42 or each row of holes 42A-D are spaced apart in the lateral direction. The first row of through holes 42A is associated with a first fastener 48A, a second row of through holes 42B associated with a second fastener 48B, a third row of through holes 42C associated with a third fastener 48C, and a fourth row of through holes 42D associated with a fourth fastener 48D.

Each panel 34, 36 of the pair of adjustable panels 34, 36 includes a bottom panel wall 50, the lock tabs 44A-C, 46A-C, and a side wall 52 as shown in FIG. 5. The bottom panel wall 50 extends from a first longitudinal edge 50A and a second longitudinal edge 50B spaced apart laterally from the first longitudinal edge 50A. The lock tabs 44A-C, 46A-C extend vertically away from the bottom panel wall 50 in a downward-vertical direction near the first longitudinal edge 50A. The side wall 52 extends vertically away from the bottom panel wall 50 in the upward-vertical direction opposite the downward-vertical direction near the second longitudinal edge 50B.

A method of using the tray system 20 includes arranging the tray system 20 in a cargo space or trunk 12 of a vehicle 10 as suggested in FIGS. 3A-4B. Arranging the tray system 20 in the trunk 12 may include coupling the left-side and right-side telescoping slide assemblies 28, 30 to a floor 14 of the trunk 12. The left-side and right-side telescoping slide assemblies 28, 30 may be arranged in spaced apart relation to one another. The expandable tray 24 may then be coupled to the slide assemblies 28, 30 once the slide assemblies 28, 30 are coupled to the vehicle 10. The expandable tray 24 may then be coupled to the slide assemblies 28, 30 by fasteners into the base plate 32.

The panels 34, 36 may already be in the desired position on the base plate 32 when the tray 24 is installed. Alternatively, the panels 34, 36 may need to be adjusted to adjust the width of the tray 24 to fit within the trunk 12. To set the width of the tray 24, the lock tabs 44A-C, 46A-C of the panels 34, 36 need to be aligned with the corresponding slots 38. The lock tabs 44, 46 may then be inserted into the slots 38 and the panels 34, 36 translated in a second longitudinal direction to misalign the tabs 44A-C, 46A-C to partially engage the locking system 26. Then the fasteners 48A-D may be inserted through the panels 34, 36 and into the base plate 32 to fully engage the locking system 26.

To adjust the width, the fasteners 48A-D may be removed before the pair of adjustable panels 34, 36 are translated in a first longitudinal direction opposite the second direction to align the lock tabs 44A-C, 46A-C with a corresponding slot 38 so that the lock fasteners 48A-D may be moved out of the corresponding slot 38. The panels 34, 36 may then be lifted in an upward-vertical direction away from the base plate 32 after translating the pair of adjustable panels 34, 36 to space the lock tabs 44A-c, 46A-C of each panel 34, 36 away from the base plate 32.

Then, the pair of adjustable panels 34, 36 may be moved in the lateral direction perpendicular to the longitudinal direction so that the pair of adjustable panels 34, 36 are spaced apart a different distance to adjust the width of the expandable tray 24. To reengage the locking system 26, the panels 34, 36 are lowered in the downward-vertical direction opposite the upward-vertical direction toward the base plate to insert the lock tabs 44A-C, 46A-C of each panel 34, 36 into the corresponding slots 38 associated with the new position. The panels 34, 36 are then translated in the second longitudinal direction opposite the first longitudinal direction to misalign the lock tabs 44A-C, 46A-C with a corresponding slots 38 so that the lock tabs 44A-C, 46A-C are unable to be moved out of the corresponding slots 38. The fasteners 48A-D are then inserted through the pair of adjustable panels 34, 36 into the base plate 32 to fully engage the locking system 26.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A tray system adapted for use in a trunk of a vehicle, the tray system comprising:
a left-side telescoping slide assembly adapted to be coupled to the trunk of the vehicle, the left-side telescoping slide assembly including interconnected, slide members moveable to extend and retract in a longitudinal direction between a retracted-storage stage and extended-service stage,
a right-side telescoping slide assembly adapted to be coupled to the trunk of the vehicle in spaced apart relation to the left-side telescoping slide assembly, the right-side telescoping slide assembly including interconnected, slide members moveable to extend and retract with the left-side telescoping slide assembly among the retracted-storage stage and the extended-service stage, and
an expandable tray coupled to the left-side and right-side telescoping slide assemblies for movement therewith, the expandable tray including:
a base plate coupled to the left-side and right-side telescoping slide assemblies, the base plate formed to include a plurality of slots formed in the base plate and spaced apart from each other in a lateral direction perpendicular to the longitudinal direction, and
a pair of adjustable panels configured to extend and retract in the lateral direction between a plurality of predetermined positions to adjust a width of the expandable tray, each panel formed to include at least one lock tab that extends away from the panel,
wherein the at least one lock tab on each panel of the plurality of adjustable panels cooperates with any one of the plurality of slots in the base plate to provide a locking system configured block the pair of adjustable panels from extending and retracting in the lateral direction when in any one of the plurality of predetermined positions once the at least one lock tab on each panel of the plurality of adjustable panels is inserted and translated in the longitudinal direction.

2. The tray system of claim 1, wherein the locking system further includes a plurality of fasteners configured to change between an inserted position in which each fastener of the plurality of fasteners extends through the pair of adjustable panels and into the base plate when the pair of adjustable panels are in any one of the plurality of predetermined positions to further block the pair of adjustable panels from extending and retracting in the lateral direction and a removed position in which each fastener of the plurality of fasteners is spaced apart from the expandable tray to allow the pair of adjustable panels to extend and retract in the lateral direction between the plurality of predetermined positions.

3. The tray system of claim 2, wherein the base plate is formed to include holes for each fastener of the plurality of fasteners and the pair of adjustable panels are each formed to include a plurality of through holes configured to align with the holes in the base plate in any one of the plurality of predetermined positions so that each fastener of the plurality of fasteners extends through one of the plurality of through holes in the pair of adjustable panels and into the hole in the base plate when in the inserted position.

4. The tray system of claim 3, wherein the plurality of fasteners includes at least four fasteners and the plurality of through holes includes a first row of through holes associated with a first fastener, a second row of through holes associated with a second fastener, a third row of through holes associated with a third fastener, and a fourth row of through holes associated with a fourth fastener.

5. The tray system of claim 1, wherein the at least one lock tab on each panel of the plurality of adjustable panels has a hook shape having a vertically-extending section that extends in a downward-vertical direction from the panel and a longitudinally-extending section that extends in the longitudinal direction from the vertically-extending section.

6. The tray system of claim 1, wherein each panel of the pair of adjustable panels is formed to include more than one lock tab spaced apart in the longitudinal direction.

7. The tray system of claim 1, wherein each panel of the pair of adjustable panels is formed to include three lock tabs spaced apart from each other in the longitudinal direction.

8. The tray system of claim 7, wherein the plurality of slots in the base plate includes three rows of slots spaced apart from each other in the longitudinal direction.

9. The tray system of claim 7, wherein the three rows of slots includes a first row of slots associated with first lock tabs on the pair of adjustable panels, a second row of slots associated with second lock tabs on the pair of adjustable panels, and a third row of slots associated with second lock tabs on the pair of adjustable panels.

10. The tray system of claim 7, wherein the lock tabs on each panel of the plurality of adjustable panels has a hook shape having a vertically-extending section that extends in a downward-vertical direction from the panel and a longitudinally-extending section that extends in the longitudinal direction from the vertically-extending section.

11. The tray system of claim 1, wherein each panel of the pair of adjustable panels includes a bottom panel wall that extends from a first longitudinal edge and a second longitudinal edge spaced apart laterally from the first longitudinal edge, the at least one lock tab that extends vertically away from the bottom panel wall in a downward-vertical direction near the first longitudinal edge, and a side wall that extends vertically away from the bottom panel wall in an upward-vertical direction opposite the downward-vertical direction near the second longitudinal edge.

12. A method comprising;
arranging a tray system in a trunk of a vehicle, the tray system comprising:
a left-side telescoping slide assembly including interconnected, slide members moveable to extend and retract in a longitudinal direction between a retracted-storage stage and extended-service stage,
a right-side telescoping slide assembly including interconnected, slide members moveable to extend and retract with the left-side telescoping slide assembly among the retracted-storage stage and the extended-service stage, and
an expandable tray coupled to the left-side and right-side telescoping slide assemblies for movement therewith, the expandable tray including (i) a base plate coupled to the left-side and right-side telescoping slide assemblies and formed to include a plurality of slots formed in the base plate and spaced apart from each other in a lateral direction perpendicular to the longitudinal direction and (ii) a pair of adjustable panels each formed to include at least one lock tab that extends away from the panel, wherein the pair of adjustable panels spaced apart at a first lateral distance,
removing a plurality of fasteners that extend through the pair of adjustable panels into the base plate,
translating the pair of adjustable panels in a first longitudinal direction to align the at least one lock tab with a corresponding slot so that the at least one lock tab may be moved out of the corresponding slot,
lifting the pair of adjustable panels in an upward-vertical direction away from the base plate after translating the pair of adjustable panels in the first longitudinal direction to space the at least one lock tab of each panel away from the base plate,
moving the pair of adjustable panels in the lateral so that the pair of adjustable panels are spaced apart at a second lateral distance that is different from the first lateral distance to adjust the width of the expandable tray,
lowering the pair of adjustable panels in a downward-vertical direction opposite the upward-vertical direction toward the base plate to insert the at least one lock tab of each panel into one slot of the plurality of slots,
translating the pair of adjustable panels in a second longitudinal direction opposite the first longitudinal direction to misalign the at least one lock tab with a corresponding slot so that the at least one lock tab is unable to be moved out of the corresponding slot, and
inserting the plurality of fasteners through the pair of adjustable panels into the base plate.
